(19) United States
(12) Patent Application Publication
(10) Pub. No.: US 2005/0187704 A1
(43) Pub. Date: Aug. 25, 2005

(54) Toy travel clock

(76) Inventor: William H. Peters, Dana Point, CA (US)

Correspondence Address: STETINA BRUNDA GARRED & BRUCKER, 75 ENTERPRISE, SUITE 250, ALISO VIEJO, CA, 92656, US

(21) Appl. No.: 11/108,569

(22) Filed: Apr. 18, 2005

Related U.S. Application Data
(63) Continuation of application No. 10/057,618, filed on Oct. 25, 2001.

(51) Int. Cl. G01C 21/26

(52) U.S. Cl. 701/201; 701/209; 340/995.23

(57) ABSTRACT

The present invention is a toy travel clock that comprises: an input device configured to accept an estimated time of travel between a starting location and a destination; a distance travel calculator configured to compute an estimated distance traveled; and an output device configured to display an indication of the estimated distance traveled. The toy travel clock graphically displays the starting location, the destination, a hypothetical route connecting the starting location to the destination, and the indication of the distance traveled along the hypothetical route.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention generally relates to toys, and more particularly to a toy travel clock.

“Are we there yet?” is a question that is very familiar to any adult who has traveled with a young child. These familiar words are often heard throughout a trip from the time the vehicle sets out on a trip (e.g., even before the car pulls out of the driveway) until the destination is reached. While hearing these words are annoying, adults should try to answer the child's question without appearing to be annoyed so that the child's curiosity is not stifled. However, often times an adult will respond with a curt “no, we are not there yet, we are two minutes closer than the last time you asked.”

Thus, a need exists for a device that will answer a child traveler's question of “are we there yet” without annoying adult travel companions.

### BRIEF SUMMARY OF THE INVENTION

In accordance with the present invention, there is provided a toy travel clock. The toy travel clock comprises: an input device configured to accept an estimated time of travel between a starting location and a destination; a distance travel calculator configured to compute an estimated distance traveled; and an output device configured to display an indication of the estimated distance traveled. The toy travel clock graphically displays the starting location, the destination, a hypothetical route connecting the starting location to the destination, and the indication of the distance traveled along the hypothetical route.

In accordance with other aspects of the invention, the toy travel clock accepts a mode of transportation. A graphical representation of the mode of transportation is displayed as the indication of the distance traveled along the hypothetical route.

In accordance with still other aspects of the invention, the estimated distance traveled is computed by calculating a time traveled by determining a difference between a start time and a current time, and dividing the time traveled by the estimated time of travel between the starting location and the destination to determine a fraction of time traveled that is equal to the estimated distance traveled.

In accordance with yet other aspects of the invention, the toy travel clock further comprises a storage module that stores at least one known destination having an associated known total distance and the input device accepts a respective known destination. The known destination may be associated with a stored known estimated time of travel between the known starting location and the known destination.

In accordance with further aspects of the invention, the toy travel clock includes a clock display indicating a current time.

In accordance with still further aspects of the invention, the toy travel clock may be a stand-alone device. Alternatively, the travel clock may be coupled to another device, for example, a gaming device display, a navigation system display or a video tape player display.

In accordance with yet further aspects of the invention, the toy travel clock may include an audio output device. The toy travel clock may output preprogrammed stories using the audio output device at designated times based on the estimated time of travel

### BRIEF DESCRIPTION OF THE DRAWINGS

These as well as other features of the present invention will become more apparent upon reference to the drawings wherein:

FIG. 1 illustrates a toy travel clock formed in accordance with the present invention;

FIG. 2 illustrates the toy travel clock of FIG. 1 with an input display for entering parameters for a trip;

FIG. 3 illustrates the toy travel clock of FIG. 1 with an output display showing a starting location, a destination and a hypothetical route;

FIG. 4 is a flow diagram illustrating exemplary logic for using the toy travel clock shown in FIG. 1; and

FIG. 5 is a flow diagram illustrating exemplary logic for entering parameters for configuring the toy travel clock of FIG. 1.

### DETAILED DESCRIPTION OF THE INVENTION

The present invention is a toy travel clock that answers the question “are we there yet?”. The invention is a toy travel clock that displays a hypothetical route between a starting location to a destination. A graphical symbol indicating the vehicle in which the child is traveling is displayed at a position along the hypothetical route that approximates the current location along the hypothetical route. In exemplary embodiments, the toy travel clock of the present invention also includes a clock display that displays the current time. The clock display may be an analog clock display, a digital clock display or both an analog and a digital clock display. The toy travel clock may include additional educational or entertainment features. For example, based on the approximate travel time, stories may be programmed to be played at predesignated times.

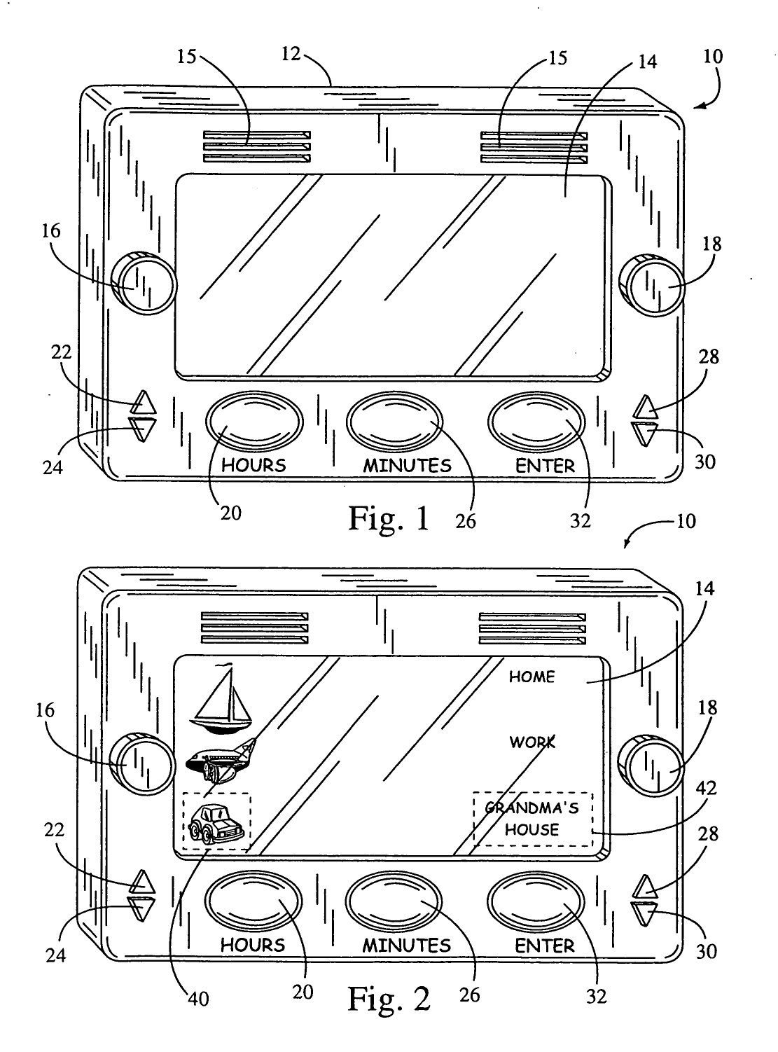

Referring now to the drawings wherein the showings are for purposes of illustrating preferred embodiments of the present invention only, and not for purposes of limiting the same, FIG. 1 illustrates a toy travel clock 10 formed in accordance with the present invention. The exemplary toy travel clock 10 illustrated herein is a stand-alone toy travel clock. However, the toy travel clock may be integrated with an existing device. Examples in which the toy travel clock may be integrated include, but are not limited to, a gaming device, such as a GameBoy™, a video cassette player, or a navigation system.

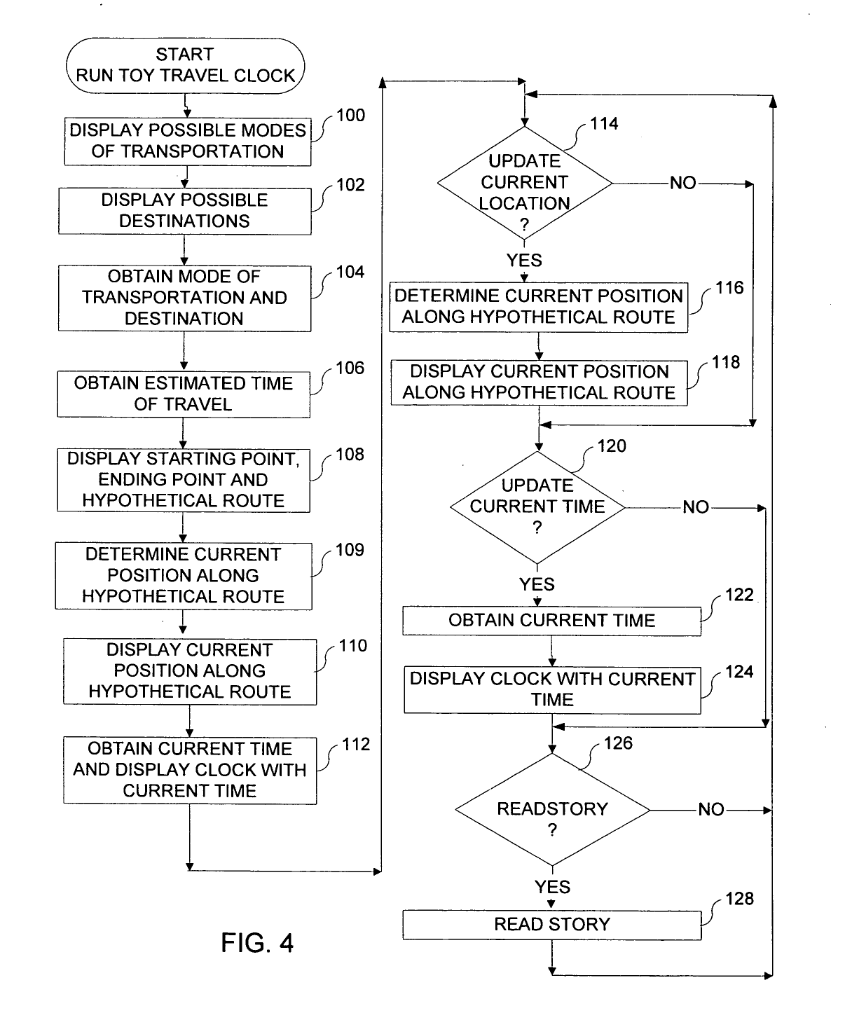

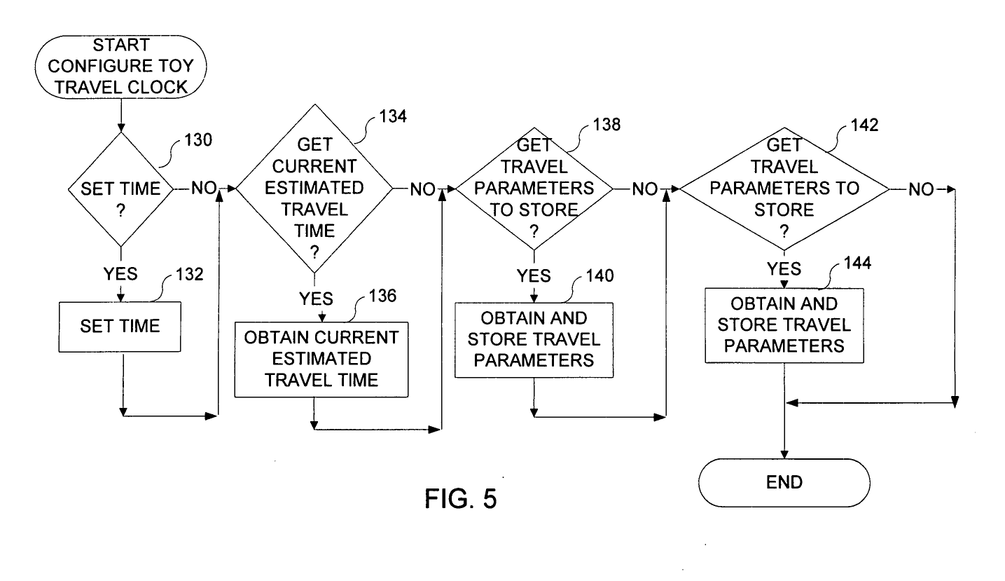

The exemplary toy travel clock shown herein includes a housing 12. The housing 12 encases components suitable for storing and executing the logic of the present invention. Logic for configuring and using the toy travel clock 10 of the present invention are shown in FIGS. 5 and 4, respectively, and are described later.

In exemplary embodiments, the toy travel clock of the present invention is powered by batteries. However, it will be appreciated that other power sources may be used, for example, the toy travel clock may be plugged into an automobile cigarette lighter. The toy travel clock 10 shown includes a display 14, speakers 15 and input controls.

The input controls may include knobs 16, 18 that are used for selecting from selections shown on the display 14. Up/Down arrows 22, 24, 28, 30 may be used instead of or in addition to knobs 16, 18 for selecting from selections shown on the display 14. The toy travel clock 10 may also include controls for specific functions, for example, an hours button 20 and a minutes button 26 may be used for entering time values, such as the current time and the approximate travel time. An enter button 32 is used to indicate completion of a selection or entry.

In exemplary embodiments, the toy travel clock 10 is turned on and off using an on/off switch (not shown). Once turned on, the toy travel clock 10 displays a start screen such as the one shown in FIG. 2. The start screen allows for the entry of a mode of transportation or vehicle. For example, as shown in FIG. 2, a plane, boat or automobile may be selected. Input controls, such as knob 16 or arrows 22, 24 may be used to select one of the available vehicles.

A destination may be selected from among stored destinations. For example, as shown in FIG. 2, pre-stored destinations may include home, work, Grandma's house, etc. Controls, such as knob 18 or arrows 28, 30 can be used to select a desired destination. In exemplary embodiments, an approximate time of travel is also entered. In yet other embodiments, an approximate distance and average speed of travel can be entered so that the approximate travel time can be calculated by dividing the approximate distance by the approximate average speed of travel. In other embodiments, a source/destination (e.g., home/grandma's house) may be stored along with an associated approximate travel time. The source/destination pair can be selected. It will be appreciated that various embodiments may include a combination of the methods for determining the approximate travel time. An indication of the starting time of travel is also required. In exemplary embodiments, a start now button may be pushed. Additionally, exemplary embodiments allow for the entry of a start time.

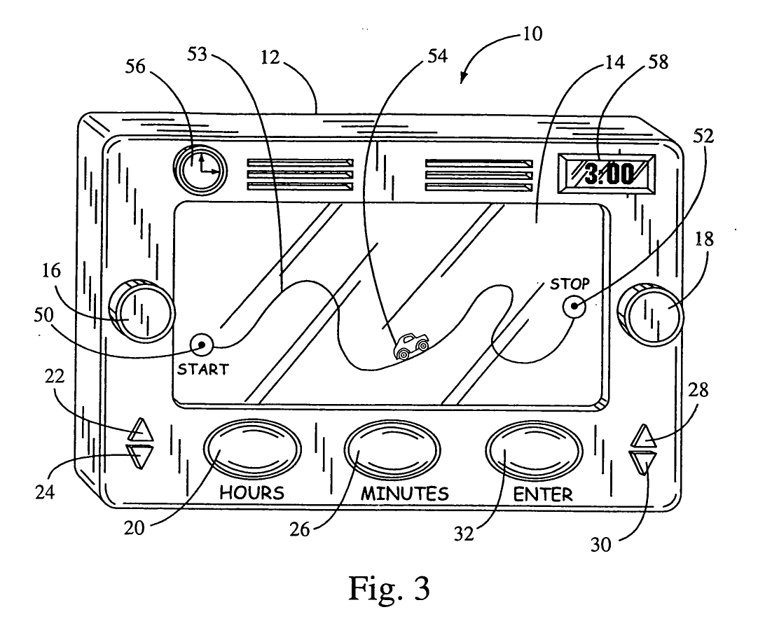

The present invention also allows for the entry and updating of the current time. In exemplary embodiments, such as the one shown in FIG. 3, the current time is displayed. The time may be displayed on an analog clock 56, a digital clock 58, or both an analog clock and a digital clock. The clock(s) may be separate from display 14 as shown in FIG. 3 or the time display may be included as part of the main display window 14.

After sufficient parameters have been entered to determine an approximate time of travel and a start travel time, a hypothetical route is determined between a starting point and an ending point (destination). The starting point 50, ending point 52 and the hypothetical route 53 connecting the starting point 50 and destination 52 is shown on the display 14. A calculation of the current position along the hypothetical route is determined by determining the fraction of time traveled. The fraction of time traveled is the difference between the current time and the start time divided by the approximate total travel time. For example, if the start time is 12:00 P.M. and it is now 1:00 P.M. and the approximate travel time is 3 hours, the fraction of time traveled thus far is ⅓. Thus, the vehicle has traveled approximately 1/3 of the total distance. A symbol representing the mode of travel 54 is displayed along the hypothetical route 53 at a position between the starting and ending position that approximates the time (and distance) traveled thus far. In exemplary embodiments, the display of the symbol is updated on a periodic timed basis, e.g., every ten minutes. Alternatively, the toy travel clock may include an “are we there yet? button, which when pressed causes the position of the vehicle symbol 54 to be updated based on a new calculation of the approximate distance traveled.

In addition to the hypothetical route displayed, exemplary embodiments may include a textual display. For example, “1 hour down, 2 hours to go.”

In addition to answering the question “are we there yet?”, the present invention may included additional educational and/or entertainment functions that are appropriate for children who are traveling. For example, the present invention may include a capability to read stories. The stories may be preprogrammed and stored in the toy travel clock. Alternatively, the toy travel clock may be able to retrieve and play audio stored on an external source, such as an audio cassette tape. Audio is output through speakers 15. In exemplary embodiments, stories are selected based on the length of the story and the approximate travel time. Alternatively, various embodiments may allow for the selection of a story to play. Various embodiments may also include games that may be played either by a single player (e.g., solitaire) and/or game that may be played by multiple players (e.g., tic tac toe, hangman, etc.).

FIG. 4 is a flow diagram illustrating exemplary logic for using a toy travel clock in accordance with the present invention. In exemplary embodiments, the logic of FIG. 4 may be invoked when the toy travel clock is powered on. It will be appreciated that in other embodiments, the present invention is integrated with an existing device, for example, a video cassette player or a navigation system. In such cases, the logic of the present invention is invoked by user request, for example, by pressing a toy travel clock button.

The logic of FIG. 4 moves from a start block to block 100 where possible modes of transportation are displayed. For example, a series of symbols depicting various modes of transportation (e.g., automobile, bus, airplane, boat, etc.) may be displayed. A user can scroll through the various options until the desired mode of transportation is selected (e.g., highlighted). Possible destinations, (for example home, office, grandmother's house, etc.) are displayed. The user may select one of the displayed destinations. See block 102. In exemplary embodiments, the entry of a specific destination (e.g., home, office, etc.) is not required.

After the user has selected the mode of transportation and the destination, the user indicates that the items have been selected (e.g., by pressing an Enter button 32). The mode of transportation and destination are obtained after the user indicates that they have been selected. See block 104.

Next, the logic proceeds to block 106 where an estimated time of travel is obtained. The estimated time of travel may be entered (e.g., by an adult). In exemplary embodiments, an estimated total travel distance and average travel speed may be entered. The estimated time of travel (in hours) is then calculated by dividing the estimated total travel distance (e.g., in miles) by the average travel speed (e.g., in miles per hour). In other embodiments, an estimated travel time may be stored with an associated starting point/destination. In yet other embodiments, a starting point/destination may have an associated distance and the estimated travel time may be calculated after an estimated average speed is entered.

After the estimated travel time is obtained, the logic moves to block 108 where a symbol representing the starting point and a symbol representing the destination (or ending point) are displayed. A hypothetical route connecting the starting point and destination is also displayed.

Next, the logic moves to block 109 where the current position along the hypothetical route is determined. As described above, the current position along the hypothetical route is the same fraction as the fraction of time traveled. The fraction of time traveled is the difference between the current time and the start time divided by the approximate total travel time. For example, if the start time is 12:00 P.M. and it is now 1:00 P.M. and the approximate travel time is three hours, the fraction of time traveled thus far is 1/3.

A symbol representing the mode of transportation is then displayed on the hypothetical route at the approximate current location relative to the starting and ending points. See block 110.

If the embodiment of the invention includes the display of a clock, the current time is obtained and displayed. See block 112. The display may be an analog clock display, a digital clock display or both an analog clock display and a digital clock display.

The display 14 is updated periodically to display the approximate current location along the hypothetical route 53 and the current time (if there is a clock display). The display 14 may be updated on a periodic basis. For example, periodic updates may occur at a preprogrammed interval (e.g., every ten minutes) or based on the estimated travel time. For example, if there are sixty updates during the estimated travel time and the estimated travel time is two hours, there will be an update every two minutes (120 minutes/60 minutes). Another method for updating the location that may be used instead of or in addition to periodic updates is an update based on user request, for example, a user pressing an “are we there yet?” button. The logic proceeds to decision block 114 to determine if it is time to update the current location. If so, the logic moves to block 116 where the current location along the hypothetical route is determined as described above with reference to block 109. The logic then moves to block 118 where the symbol is deleted from the display 14 and redrawn at the new current location along the hypothetical route.

If it is not time for an update (no in decision block 114) or after an update has been performed (blocks 116-118), the logic moves to decision block 120 to determine if the clock display should be updated. If there is a clock displayed, the time is updated on a periodic basis. If the time should be updated, the logic moves to block 122 to obtain the current time. In exemplary embodiments, the present invention includes a built-in clock. After the time has been displayed, it is displayed on the toy travel clock display. See block 124.

If the time display should not be updated (no in decision block 120) or after the time has been updated (blocks 122-124), the logic moves to decision block 126 to see if it is time to read a story. If it is time to read a story, the logic moves to block 128 where a story is retrieved and the audio for the story is played. The logic then returns to decision block 114. The logic of blocks 114-128 is repeated. The logic may stop based on various events, such as turning off the toy travel clock, expiration of the estimated time of travel, etc. In exemplary embodiments, if the estimated time of travel changes (e.g., increases due to unexpected traffic) during the travel, the estimated time of travel can be changed.

It will be appreciated that not all embodiments of the present include a story-telling function. It will also be appreciated that exemplary embodiments may include other timed functions (not shown) that will be performed instead of or in addition to the story telling feature. It will also be appreciated that various user requested options may be available in various embodiments. For example, a story may be requested or games may be played. In exemplary embodiments, the logic continually checks for user inputs and performs an appropriate function based on the user input.

It will be appreciated that the present invention requires some configuration (e.g., input of parameters by an adult). FIG. 5 is a flow diagram illustrating exemplary logic for configuring the toy travel clock 10 of the present invention. In exemplary embodiments, a configuration display allows a user (e.g., a parent to select which parameters, if any, should be set). Exemplary parameters include time, estimated time of travel, estimated distance, estimated travel speed, stories, etc. FIG. 5 illustrates exemplary logic for configuring an embodiment of the present invention. It will be appreciated that different and/or additional configuration parameters may be used for alternative embodiments.

The logic of FIG. 5 moves from a start block to decision block 130 to determine if the current time should be changed. If so, the logic moves to block 132 where an updated time value is entered and stored. Next, the logic moves to decision block 134 to determine if new time of travel parameters should be entered. If so, the logic proceeds to block 136 where current estimated time of travel parameters are entered by a user and stored by the toy travel clock of the present invention. A value for the estimated time of travel may be entered. Alternatively, values may be entered for an estimated travel distance and average speed of travel. Additionally, the estimated time of travel may be selected from pre-stored times of travel (e.g., a stored starting point and destination). The estimated time of travel may also be determined based on a combination of stored values and entered values. For example, a starting point/destination may have an associated stored distance. A stored distance requires the entry of an estimated average speed of travel to determine the estimated time of travel.

As described above, parameters, e.g., estimated time of travel or distance maybe stored. The logic moves to decision block 138 to determine if parameters should be stored. If so, the logic moves to block 140 where the desired parameter(s) are entered by a user and stored in the toy travel clock.

Next, the logic proceeds to decision block 142 to determine if story information should be stored. For example, stories may be retrieved from an outside source and stored in the toy travel clock. Parameters may also be entered for the playing of stories. For example, parameters may be entered specifying a starting time for specific stories. If story parameters should be entered, the logic moves to block 144 where story parameters will be entered. The logic of FIG. 5 then ends. It will be appreciated that additional and/or different configuration parameters may be used.

Additional modifications and improvements of the present invention may also be apparent to those of ordinary skill in the art. Thus, the particular combination of parts described and illustrated herein is intended to represent only one embodiment of the present invention, and is not intended to serve as limitations of alternative devices within the spirit and scope of the invention.

1-18. (canceled)

19. A method for generating a hypothetical route of travel, the method comprising:
a) accepting an estimated time of travel from a starting location to a destination;
b) determining the hypothetical route from the starting location to the destination in response to the estimated time of arrival;
c) outputting for visual perception the starting location, the destination, and the hypothetical route connecting the starting location to the destination;
d) calculating a current position along the hypothetical route; and
e) outputting for visual perception a graphical symbol, the graphical symbol being representative of a vehicle at the current position along the hypothetical route.

20. The method recited in claim 19, wherein step (a) comprises: accepting a selection of a known location that has an associated stored estimated time of travel from the starting location to the destination.

21. The method recited in claim 19, wherein step (a) comprises:
a) accepting a known location that has an associated stored distance from the starting location to the destination;
b) accepting an estimated speed of travel; and
c) calculating the estimated time of travel by dividing the associated stored distance from the starting location to the destination by the estimated speed of travel.

22. The method recited in claim 19, wherein step (d) comprises calculating the current position along the hypothetical route by:
a) calculating a time traveled being equal to the difference between a start time and a current time; and
b) dividing the time traveled by the estimated time of travel between the starting location and the destination to determine a fraction of time traveled that is equal to the estimated distance traveled.

23. The method recited in claim 19, further comprising accepting a mode of transportation, and wherein step (e) comprises outputting for visual perception a graphical symbol of a vehicle being representative of the mode of transportation at the current position along the hypothetical route.

24. A method of generating a hypothetical route of travel utilizing an electronic device including an input device, a calculator, and a display device, the method comprising:
a) inputting into the input device an estimated time of travel from a starting location to a destination;
b) determining the hypothetical route from the starting location to the destination in response to the estimated time of arrival utilizing the calculator;
c) graphically displaying on the display device the starting location, the destination, and the hypothetical route connecting the starting location to the destination;
d) calculating a current position along the hypothetical route utilizing the calculator; and
e) displaying a graphical symbol on the display device, the graphical symbol being representative of a vehicle at the current position along the hypothetical route.

25. The method recited in claim 24, wherein the calculator includes an associated stored time of travel from the starting location to the destination for a respective known location, and step (a) further comprises: inputting a selection of the known location that has the associated estimated time of travel.

26. The method recited in claim 24, wherein the calculator includes an associated stored distance from the starting location to the destination for a respective known location, and step (a) further comprises:
a) inputting the known location that has the associated stored distance utilizing the input device;
b) inputting an estimated speed of travel utilizing the input device; and
c) calculating the estimated time of travel by dividing the associated stored distance from the starting location to the destination by the estimated speed of travel utilizing the calculator.

27. The method recited in claim 24, wherein step (d) comprises calculating the current position along the hypothetical route by:
a) calculating a time traveled being equal to the difference between a start time and a current time; and
b) dividing the time traveled by the estimated time of travel between the starting location and the destination to determine a fraction of time traveled that is equal to the estimated distance traveled.

28. The method recited in claim 24, further comprising inputting a mode of transportation into the input device, and wherein step (e) comprises displaying on the display device a graphical symbol of a vehicle being representative of the mode of transportation at the current position along the hypothetical route.
